(19) United States
(12) Patent Application Publication
(10) Pub. No.: US 2008/0080642 A1
(43) Pub. Date: Apr. 3, 2008

(54) APPARATUS AND METHOD FOR ENCODING/DECODING DATA IN MULTIPLE ANTENNA COMMUNICATION SYSTEM

(75) Inventors: Jong-Ho LEE, Seoul (KR); Sang-Boh YUN, Seongnam-si (KR); Dae-Young PARK, Seoul (KR); Joo-Hyun LEE, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 11/864,444

(22) Filed: Sep. 28, 2007

(30) Foreign Application Priority Data
Sep. 29, 2006 (KR) 2006-0096015

(51) Int. Cl. H04L 27/00

(52) U.S. Cl. 375/299; 375/340

(57) ABSTRACT

A data encoding/decoding method in a multiple antenna communication system is provided. In the multiple antenna communication system, a transmitting end includes an encoder for performing Space Time Block Code (STBC) encoding on certain symbols among Transmit (Tx) symbols, a multiplexer for performing spatial multiplexing on the rest of symbols among the Tx symbols, and a transmitter for transmitting the STBC encoded symbols and the spatial-multiplexed symbols through a plurality of antennas.

### PRIORITY

This application claims the benefit under 35 U.S.C. § 119(a) of a Korean patent application filed in the Korean Intellectual Property Office on Sep. 29, 2006 and assigned Serial No. 2006-96015, the entire disclosure of which is hereby incorporated by reference.

### BACKGROUND OF THE INVENTION

1. Field of the Invention

The present invention relates to a multiple antenna communication system. More particularly, the present invention relates to an apparatus and method for encoding/decoding data in a multiple antenna communication system.

2. Description of the Related Art

Recently, with the rapid growth of a wireless telecommunication market, there is a demand for a variety of multimedia services in a wireless environment. To meet this demand, an amount of transmission data becomes large, and a speed of data transmission increases. In addition, a method for effectively using frequency resources is demanded since frequency resources are limited. Therefore, a new transmission technique using a multiple antenna system is required, and a Multiple Input Multiple Output (MIMO) system using multiple antennas is now being used.

In the multiple antenna system, multiple antennas are used at both a transmitting end and a receiving end. Compared with a system using a single antenna, the multiple antenna system can increase channel transmission capacity in proportion to the number of antennas without having to additionally allocate a frequency or transmission power. As a result, researches on the MIMO system are actively being conducted these days.

MIMO technologies are classified into a spatial diversity scheme, a Spatial Multiplexing (SM) scheme and a combination scheme of the spatial diversity scheme and the SM scheme. The spatial diversity scheme can obtain a diversity gain corresponding to the multiplication of a number of Transmit (Tx) antennas and a number of Receive (Rx) antennas, thereby improving transmission reliability. The SM scheme can simultaneously transmit data streams, thereby increasing data throughput.

When different data streams are transmitted from a plurality of transmitting ends according to the SM scheme, interference occurs between the simultaneously transmitted data streams. Therefore, a receiving end detects signals in consideration of the influence of interference signal. In general, performance and computational complexity can be traded off in a signal detection process using the SM scheme. Recently, a signal detection algorithm is actively studied in that computational complexity decreases and performance is maximized.

Signal detection methods using the SM scheme will now be described.

First, in a Maximum Likelihood (ML) method, a combination of symbols is selected in consideration of combinations of all possible symbols s₀ that a Euclidean distance is minimized with respect to a combination of actually received symbols. Thus, signal detection can be achieved with a minimum error rate. However, when the ML method uses N antennas and a constellation having M symbols, the Euclidean distance has to be computed for combinations of MN symbols. That is, since computational complexity exponentially increases along with the increase in the number of antennas, implementation is not possible in practice.

Second, in a Modified ML (MML) method, signal detecting is performed using the ML method by excluding an arbitrary antenna from a plurality of antennas. Thereafter, for the excluded antenna, a Tx signal may be simply detected using previously detected signals. That is, in the ML method, a Euclidean distance is computed for combinations of M^{N} symbols, whereas in the MML method, the Euclidean distance is computed for combinations of M^{N-1} symbols.

Third, in a Sorted-MML (SMML) method, a Givens rotation matrix is used to null channels, and thus a subsystem is generated. Then, signal detection is performed according to the MML method by using a 2×2 subsystem that is a minimum unit. Thereafter, according to channel information of the detected 2×2 subsystem, a symbol is detected by removing interference of a 3×3 subsystem using a Successive Interference Cancellation (SIC) scheme, and such symbol detection process is repeated for all antennas. The SMML method requires less computational complexity than the ML or MML method. However, since combinations of all possible symbols are taken into account for signal detection using the 2×2 subsystem, a Euclidean distance has to be computed for combinations of M² symbols.

As such, a method of reducing computational complexity in a multiple antenna communication system is demanded. However, a problem still remains in that significantly large amount of computations are required since a Euclidean distance is computed for combinations of all possible symbols even though the number of times of performing computation may differ from one detection method to another.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for detecting a Receive (Rx) symbol in a multiple antenna communication system.

Another aspect of the present invention is to provide an apparatus and method for reducing computational complexity when symbol detection is performed in a multiple antenna communication system.

Still another aspect of the present invention is to provide an apparatus and method in which a Space Time Block Code (STBC) is used for antennas included in a multiple antenna communication system.

According to an aspect of the present invention, a transmitting apparatus in a multiple antenna communication system is provided. The transmitting apparatus comprises an encoder for performing STBC encoding on certain symbols among Transmit (Tx) symbols, a multiplexer for performing spatial multiplexing on the rest of symbols among the Tx symbols, and a transmitter for transmitting the STBC encoded symbols and the spatial-multiplexed symbols through a plurality of antennas.

According to another aspect of the present invention, a transmitting apparatus in a multiple antenna communication system is provided. The transmitting apparatus comprises an encoder for performing STBC encoding on certain symbols among Tx symbols and for performing spatial multiplexing on the rest of symbols among the Tx symbols, and a transmitter for transmitting symbols received from the encoder through a plurality of antennas.

According to another aspect of the present invention, a receiving apparatus in a multiple antenna communication system is provided. The receiving apparatus comprises a generator for sorting estimated channels and for generating a subsystem by nulling certain channels among the sorted channels, a decoder for performing STBC decoding on signals received through certain antennas in association with the subsystem among a plurality of antennas, so as to estimate Tx symbols, and a detector for estimating symbols received through the rest of antennas by using the estimated Tx symbols.

According to still another aspect of the present invention, a signal transmission method in a multiple antenna communication system is provided. The signal transmission method comprises performing STBC encoding on certain symbols among Tx symbols, performing spatial multiplexing on the rest of symbols among the Tx symbols, and transmitting the STBC encoded symbols and the spatial-multiplexed symbols through a plurality of antennas.

According to yet another aspect of the present invention, a signal detection method in a multiple antenna communication system is provided. The signal detection method comprises sorting estimated channels and generating a subsystem by nulling certain channels among the sorted channels, performing STBC decoding on signals received through certain antennas in association with the subsystem among a plurality of antennas, so as to estimate Tx symbols, and estimating symbols received through the rest of antennas by using the estimated Tx symbols.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 is a block diagram of a transmitting end in a multiple antenna communication system according to an exemplary embodiment of the present invention;

FIG. 2 is a block diagram of a receiving end in a multiple antenna communication system according to an exemplary embodiment of the present invention;

FIG. 3 is a flowchart illustrating a data encoding process performed by a transmitting end in a multiple antenna communication system according to an exemplary embodiment of the present invention;

FIG. 4 is a flowchart illustrating a data decoding process performed by a receiving end in a multiple antenna communication system according to an exemplary embodiment of the present invention; and

FIGS. 5A to 5C are graphs illustrating performance when data is encoded and decoded according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

A technique of the present invention will be described hereinafter in which computational complexity is reduced when symbol detection is performed in a receiving end by using a Space-Time Block Code (STBC) for antennas included in a multiple antenna communication system. It will be assumed hereinafter that a transmitting end and the receiving end of the multiple antenna communication system respectively use four Transmit (Tx) antennas and four Receive (Rx) antennas. The same may also be applied to another embodiment as long as a communication system uses a plurality of antennas. In addition, it will be assumed hereinafter that the STBC uses an Alamouti scheme.

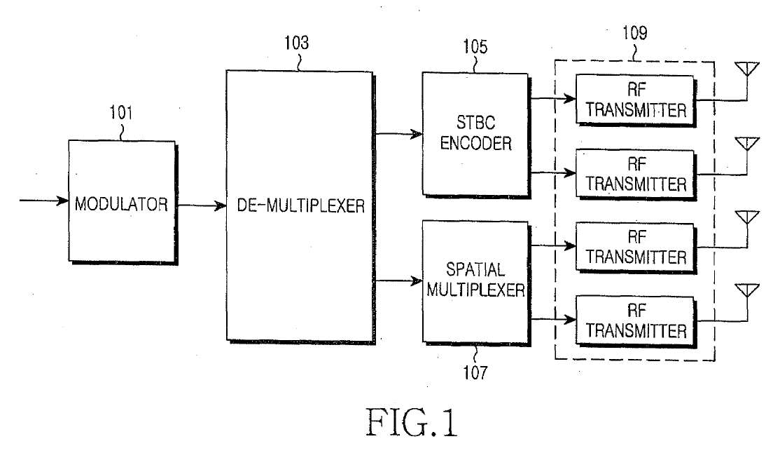

FIG. 1 is a block diagram of a transmitting end in a multiple antenna communication system according to an exemplary embodiment of the present invention.

Referring to FIG. 1, the transmitting end includes a modulator 101, a de-multiplexer 103, a STBC encoder 105, a spatial multiplexer 107 and a Radio Frequency (RF) transmitter 109.

The modulator 101 modulates data to be transmitted to the transmitting end by using a modulation method and then generates complex symbols.

The de-multiplexer 103 de-multiplexes the symbols provided from the modulator 101 and outputs the resultant symbols to the STBC encoder 105 and the spatial multiplexer 107. According to an exemplary embodiment of the present invention, the symbols are not simultaneously output to the STBC encoder 105 and the spatial multiplexer 107. That is, two symbols are output to the STBC encoder 105 while four symbols are output to the spatial multiplexer 107. For example, if symbols s₀, s₁, s₂, s₃, s₄, and s₅ are sequentially input, and the symbols s₀ and s₁ are subject to STBC encoding, then the de-multiplexer 103 outputs the following symbols as described in Table 1 below.

TABLE 1

| | t₁ | t₂ | t₃ | t₄ |
|---|---|---|---|---|
| symbols output to STBC encoder | S₀ | S₁ | X | X |
| Symbols output to spatial multiplexer | S₂ | S₃ | S₄ | S₅ |

Referring to Table 1 above, at t₁ and t₂, the de-multiplexer 103 outputs the symbols s₀ and s₁ to the STBC encoder 105. Further, at t₁, t₂, t₃, and t₄, the de-multiplexer 103 outputs the symbols s₂, s₃, s₄, and s₅ to the spatial multiplexer 107.

The STBC encoder 105 performs STBC encoding on the symbols provided from the de-multiplexer 103. For example, if the symbols s₀ and s₁ are provided and the Alamouti-STBC is used, then symbols output to the STBC encoder 105 are expressed by Equation (1) below.

$$[ \begin{matrix}- {s}_{1}^{*} & {s}_{0} \\ {s}_{0}^{*} & {s}_{1}\end{matrix} ] \qquad ( 1 )$$

In Equation (1) above, each row denotes Tx symbols for each antenna, and each column denotes time periods for transmitting symbols. Specifically, during a first time period, the symbol s₀ is transmitted through a 0^{th} antenna and the symbol s₁ is transmitted through a first antenna. Further, during a second time period, the symbol −s₁* is transmitted through the 0^{th} antenna and the symbol s₀* is transmitted through the first antenna.

As such, the STBC encoder 105 performs STBC encoding in the transmitting end, and thus the symbol transmitted through the two antennas can be detected in the receiving end by simply performing STBC decoding.

According to the number of antennas, the spatial multiplexer 107 performs spatial multiplexing on the symbols provided from the de-multiplexer 103. For example, if the symbols s₂, s₃, s₄, and s₅ are provided, output symbols are expressed by Equation (2) below.

$$[ \begin{matrix}{s}_{4} & {s}_{2} \\ {s}_{5} & {s}_{3}\end{matrix} ] \qquad ( 2 )$$

In Equation (2), each row denotes Tx symbols for each antenna, and each column denotes time periods for transmitting symbols. Specifically, during a first time period, the symbol s₂ is transmitted through a second antenna, and the symbol s₃ is transmitted through a third antenna. Further, during a second time period, the symbol s₄ is transmitted through the second antenna, and the symbol s₅ is transmitted through the third antenna.

The RF transmitter 109 converts baseband signals provided from the STBC encoder 105 and the spatial multiplexer 107 into RF signals, and transmits the converted signals through respective antennas.

In FIG. 1, the STBC encoder 105 and the spatial multiplexer 107 are depicted in separate blocks. This is for explanation purpose only, and thus the STBC encoder 105 and the spatial multiplexer 107 may be optionally constructed of one block.

Two Tx antennas to perform STBC encoding could be determined by a transmitting end or by a receiving end. In the first case that the transmitting end determines the two Tx antennas to perform STBC encoding, the transmitting end selects the two Tx antennas which correspond to the smallest inter-channel correlation or the two Tx antennas which correspond to the smallest values among the maximum singular values of channel matrix. In this case, the transmitting end includes a message generator (not shown) that generates a control message containing the two Tx antenna information. The message generator generates the control message and provides the control message to the RF transmitter 109. The RF transmitter 109 transmits the control message to the receiving end through a control channel.

In the second case that the receiving end determines the two Tx antennas to perform STBC encoding, the transmitting end selects the two Tx antennas according to a control message fed back from the receiving end. In this case, the transmitting end includes a message checker (not shown) that evaluates the control message containing the two Tx antennas information. In the second case, the receiving end determines the two Tx antennas in a similar manner to the way the transmitting end does.

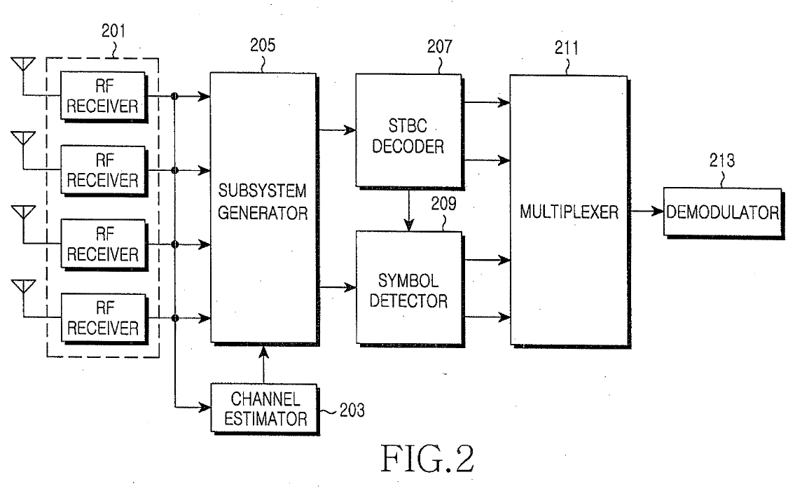

FIG. 2 is a block diagram of a receiving end in a multiple antenna communication system according to an exemplary embodiment of the present invention.

Referring to FIG. 2, the receiving end includes an RF receiver 201, a channel estimator 203, a subsystem generator 205, an STBC decoder 207, a symbol detector 209, a multiplexer 211 and a demodulator 213.

The RF receiver 201 converts RF signals received from respective antennas into baseband signals. The channel estimator 203 estimates a channel for each antenna by using the signals provided from the RF receiver 201. Rx signals are expressed by Equation (3) below by using estimated channel values.

$$y = [ {h}_{0} {h}_{1} {h}_{2} {h}_{3} ] [ \begin{matrix}{s}_{0} \\ {s}_{1} \\ {s}_{2} \\ {s}_{3}\end{matrix} ] + n \qquad ( 3 )$$

In Equation (3) above, y denotes an Rx signal vector, hₖ denotes a channel vector for a k^{th} antenna, sₖ denotes a Tx symbol for the k^{th} antenna, and n denotes noise.

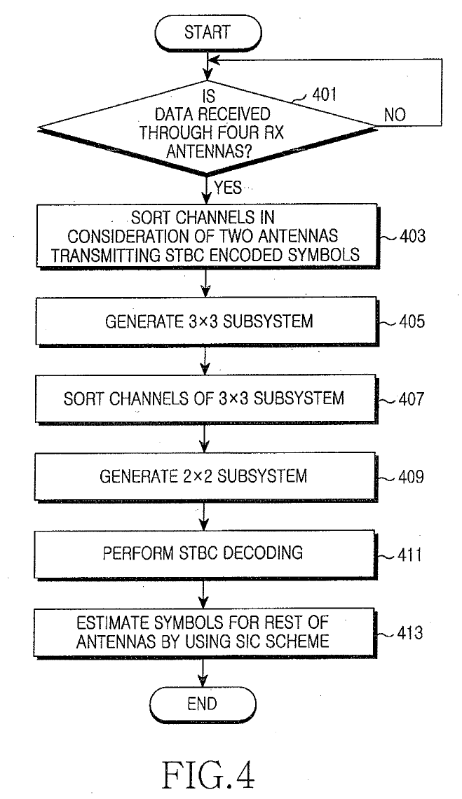

The subsystem generator 205 receives a channel vector for each antenna from the channel estimator 203 and generates a subsystem. Specifically, to generate the subsystem, the subsystem generator 205 sorts the channel vectors in either descending or ascending order of the magnitudes of the channel vectors, and nulls channels by using a Givens rotation matrix. The subsystem generation process will be described in detail with reference to FIG. 4. In particular, the channel vectors are sorted so that a 2×2 subsystem can be generated regardless of the magnitudes of channel vectors for antennas transmitting STBC encoded signals and channels for the antennas transmitting STBC encoded signals are not nulled. For example, the channel vectors may be sorted as Expressed by Equation (4) below where h₀ and h₁ denote the channel vectors of the antennas receiving the STBC encoded signals.

$$\vert {h}_{1} \vert > \vert {h}_{2} \vert > \vert {h}_{3} \vert > \vert {h}_{0} \vert \\ * descending sort y = [ {h}_{2} {h}_{3} {h}_{0} {h}_{1} ] [ \begin{matrix}{s}_{2} \\ {s}_{3} \\ {s}_{0} \\ {s}_{1}\end{matrix} ] + n \\ * ascending sort y = [ {h}_{3} {h}_{2} {h}_{0} {h}_{1} ] [ \begin{matrix}{s}_{3} \\ {s}_{2} \\ {s}_{0} \\ {s}_{1}\end{matrix} ] + n \qquad ( 4 )$$

In Equation (4) above, y denotes an Rx signal vector, hₖ denotes a channel vector for a k h antenna, sₖ denotes a Tx symbol for the k^{th} antenna, and n denotes noise.

In addition, the subsystem may be generated using Equation (5) below.

$$y = [ {h}_{2} {h}_{3} {h}_{0} {h}_{1} ] [ \begin{matrix}{s}_{2} \\ {s}_{3} \\ {s}_{0} \\ {s}_{1}\end{matrix} ] + n \\ {y}^{′} = [ {h}_{3}^{′} {h}_{0}^{′} {h}_{1}^{′} ] [ \begin{matrix}{s}_{3} \\ {s}_{0} \\ {s}_{1}\end{matrix} ] + n \\ {y}^{″} = [ {h}_{0}^{″} {h}_{1}^{″} ] [ \begin{matrix}{s}_{0} \\ {s}_{1}\end{matrix} ] + n \qquad ( 5 )$$

In Equation (5) above, y denotes an Rx signal vector, hₖ denotes a channel vector for a k^{th} antenna, sₖ denotes a Tx symbol for the k^{th} antenna, n denotes noise, y′ denotes an Rx signal vector of a 3×3 subsystem, h′ₖ denotes a channel vector of a 3×3 subsystem for a k^{th} antenna, y″ denotes an Rx signal vector of a 2×2 subsystem, and h″ₖ denotes a channel vector of a 2×2 subsystem for a k^{th} antenna.

The STBC decoder 207 performs STBC decoding on Rx signals of a 2×2 subsystem provided from the subsystem generator 205 and then estimates Tx symbols. Further, in order to estimate symbols for the rest of antennas, the STBC decoder 207 provides symbol values obtained as a result of the STBC decoding to the symbol detector 209. Signals received during two consecutive time periods are used in the STBC decoding. Therefore, the STBC decoder 207 first buffers signals previously received respectively through two antennas among a total of four antennas and thereafter performs STBC decoding by using a total of four Rx signals.

The symbol detector 209 receives, from the STBC decoder 207, two symbol values estimated using the 2×2 subsystem, and receives subsystem information from the subsystem generator 205, thereby detecting Rx symbols. That is, the symbol detector 209 estimates symbols for the rest two antennas among the four antennas by using a Successive Interference Cancellation (SIC) scheme. For example, if a subsystem is generated as expressed by Equation (5) above, the symbol detector 209 removes interference caused by the symbols s₀ and s₁ of a 3×3 subsystem, and thereafter estimates the symbol s₃. Likewise, the symbol detector 209 removes interference caused by the symbols s₀, s₁, and s₃ of a 4×4 subsystem, and thereafter estimates the symbol s₂.

The multiplexer 211 multiplexes a plurality of symbols provided from the STBC decoder 207 and the symbol detector 209. The demodulator 213 demodulates the symbols provided from the multiplexer 211 according to a demodulation method.

In this case, the receiving end has to know two Tx antennas that transmits a STBC encoded signal. The two Tx antennas to perform STBC encoding could be determined by a transmitting end or by a receiving end. In the first case that the transmitting end determines the two Tx antennas to perform STBC encoding, the receiving end can obtain the two Tx antennas information via a control message. In this case, the receiving end includes a message checker (not shown) that evaluates the control message containing the two Tx antenna information. The RF receiver 201 receives the control message through a control channel and provides it to the message checker. Then, the message checker evaluates the two Tx antenna information through the control channel and provides the evaluation result to the subsystem generator 205.

In the second case that the receiving end determines the two Tx antennas to perform STBC encoding, the receiving end selects the two Tx antennas which correspond to the smallest inter-channel correlation or the two Tx antennas which correspond to the smallest values among the maximum singular values of channel matrix. In this case, the receiving end includes a message generator (not shown) that generates a control message containing the two Tx antennas information. And the control message is transmitted to the transmitting end. Thus, the receiving end includes a transmitter (not shown) that transmits the control message to transmitting end.

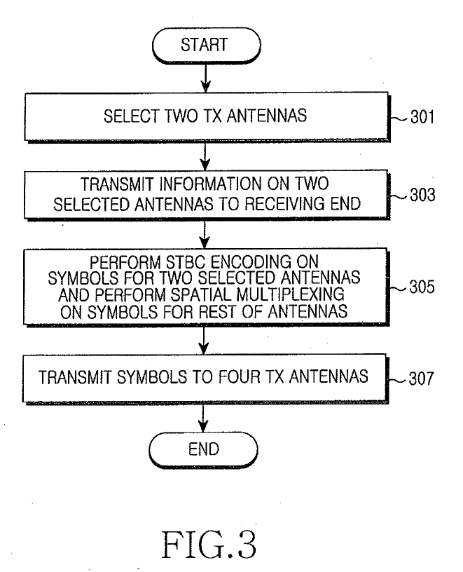

FIG. 3 is a flowchart illustrating a data encoding process performed by a transmitting end in a multiple antenna communication system according to an exemplary embodiment of the present invention.

Referring to FIG. 3, in step 301, two Tx antennas are selected from a total of four Tx antennas so as to perform STBC encoding. The two Tx antennas to perform STBC encoding could be determined by a transmitting end or by a receiving end. In the first case that the transmitting end determines the two Tx antennas to perform STBC encoding, the transmitting end selects the two Tx antennas which correspond to the smallest inter-channel correlation or the two Tx antennas which correspond to the smallest values among the maximum singular values of channel matrix. In the second case that the receiving end determines the two Tx antennas to perform STBC encoding, the transmitting end selects the two Tx antennas according to control message fed back from the receiving end. In the second case, the receiving end determines the two Tx antennas in a similar manner to the way the transmitting end does.

In step 303, information on the two selected antennas is transmitted to the receiving end. This information is transmitted through a control channel prior to the transmission of data since the information is required in a data detection process. If the receiving end determines the two Tx antennas to perform STBC encoding, the step 303 is omitted.

In step 305, symbols to be transmitted to the two selected Tx antennas are subject to STBC encoding. Symbols for the remaining two Tx antennas are subject to spatial-multiplexing.

In step 307, the STBC encoded symbols and the spatial multiplexed symbols are transmitted through the four Tx antennas. In this step, a STBC encoded signal comprises four symbols transmitted through the respective antennas during two consecutive time periods for transmitting symbols. For example, the transmitting end may transmit symbols expressed by Equation (6) below.

$$[ \begin{matrix}- {s}_{1}^{*} & {s}_{0} \\ {s}_{0}^{*} & {s}_{1} \\ {s}_{4} & {s}_{2} \\ {s}_{5} & {s}_{3}\end{matrix} ] \qquad ( 6 )$$

In Equation (6) above, each row denotes Tx symbols for each antenna, and each column denotes time periods for transmitting symbols. That is, during a first time period, the symbols s₀, s₁, s₂, and s₃ are transmitted through the four antennas, and during a second time period, the symbols −s₁*, s₀*, s₄, and s₅ are transmitted through the four antennas.

FIG. 4 is a flowchart illustrating a data decoding process performed by a receiving end in a multiple antenna communication system according to an exemplary embodiment of the present invention.

Referring to FIG. 4, in step 401, the receiving end determines whether signals are received through four Rx antennas.

Upon receiving the signals through the four Rx antennas, in step 403, channel vectors are sorted in consideration of two Tx antennas through which STBC encoded signals are transmitted. In this step, the channel vectors are sorted in either descending or ascending order of channel magnitudes. For example, in consideration of the magnitude of a channel vector expressed by Equation (4) above, the channel vectors are sorted so that channels for antennas receiving the STBC encoded signals are not nulled, and as a result, a 2×2 subsystem is generated. Information on the two Tx antennas is received from the transmitting end through a control channel prior to the reception of a data signal or is determined by the receiving end. In case that the two Tx antennas are determined by the receiving end, the receiving end determines two Tx antennas which correspond to the smallest inter-channel correlation or two Tx antennas which correspond to the smallest values among the maximum singular values of channel matrix. And a control message containing the information on the two Tx antennas is transmitted to the transmitting end prior to the reception of a data signal.

In step 405, a 3×3 subsystem is generated by using a Givens rotation matrix. For example, the 3×3 subsystem may be generated as expressed by Equations (7) and (8) below. Equation (7) below is used to null a channel h_{4,3} between a fourth Rx antenna and a third Tx antenna in a 4×4 subsystem.

$${G}_{( 4 , 1 )} {H}_{( 4 \times 4 )} = [ \begin{matrix}{h}_{1 , 2}^{′} & {h}_{1 , 3}^{′} & {h}_{1 , 0}^{′} & {h}_{1 , 1}^{′} \\ {h}_{2 , 2}^{′} & {h}_{2 , 3}^{′} & {h}_{2 , 0}^{′} & {h}_{2 , 1}^{′} \\ {h}_{3 , 2}^{′} & {h}_{3 , 3}^{′} & {h}_{3 , 0}^{′} & {h}_{3 , 1}^{′} \\ 0 & {h}_{4 , 3}^{′} & {h}_{4 , 0}^{′} & {h}_{4 , 1}^{′}\end{matrix} ] \qquad ( 7 )$$

Herein, G(4, 1) is represented by

$$[ \begin{matrix}1 & 0 & 0 & 0 \\ 0 & 1 & 0 & 0 \\ 0 & 0 & c & s \\ 0 & 0 & - {s}^{*} & c\end{matrix} ] ,$$

where c is

$$\frac{\vert {h}_{3 , 3} \vert}{\sqrt{{\vert {h}_{4 , 3} \vert}^{2} + {\vert {h}_{3 , 3} \vert}^{2}}} ,$$

and s is

$$\frac{{h}_{3 , 3} {h}_{4 , 3}^{*}}{\vert {h}_{3 , 3} \vert \sqrt{{\vert {h}_{4 , 3} \vert}^{2} + {\vert {h}_{3 , 3} \vert}^{2}}} .$$

### Further, H(4×4) is represented by

$$[ \begin{matrix}{h}_{1 , 2} & {h}_{1 , 3} & {h}_{1 , 0} & {h}_{1 , 1} \\ {h}_{2 , 2} & {h}_{2 , 3} & {h}_{2 , 0} & {h}_{2 , 1} \\ {h}_{3 , 2} & {h}_{3 , 3} & {h}_{3 , 0} & {h}_{3 , 1} \\ {h}_{4 , 2} & {h}_{4 , 3} & {h}_{4 , 0} & {h}_{4 , 1}\end{matrix} ]$$

and denotes a 4×4 multiple antenna system.

Similar to Equation (7) above, by sequentially multiplying G(4,2) and G(4,3), Equation (8) below is obtained.

$${G}_{( 4 )} {H}_{( 4 \times 4 )} = [ \begin{matrix}{h}_{1 , 2}^{′} & {h}_{1 , 3}^{′} & {h}_{1 , 0}^{′} & {h}_{1 , 1}^{′} \\ 0 & {h}_{2 , 3}^{′} & {h}_{2 , 0}^{′} & {h}_{2 , 1}^{′} \\ 0 & {h}_{3 , 3}^{′} & {h}_{3 , 0}^{′} & {h}_{3 , 1}^{′} \\ 0 & {h}_{4 , 3}^{′} & {h}_{4 , 0}^{′} & {h}_{4 , 1}^{′}\end{matrix} ] \qquad ( 8 )$$

Herein, G(4) denotes G(4,3)G(4,2)G(4,1), where G(4,2) denotes

$$[ \begin{matrix}1 & 0 & 0 & 0 \\ 0 & c & s & 0 \\ 0 & - {s}^{*} & c & 0 \\ 0 & 0 & 0 & 1\end{matrix} ] and G ( 4 , 3 ) denotes [ \begin{matrix}c & s & 0 & 0 \\ - {s}^{*} & c & 0 & 0 \\ 0 & 0 & 1 & 0 \\ 0 & 0 & 0 & 1\end{matrix} ] .$$

After generating the 3×3 subsystem, in step 407, channel vectors of the 3×3 subsystem are sorted. In this step, channels for antennas transmitting STBC encoded signals are not nulled.

In step 409, a 2×2 subsystem is generated using the Givens rotation matrix.

In step 411, STBC decoding is performed on Rx signals of the 2×2 subsystem, and then symbols for two antennas are estimated. Signals received for two consecutive time periods for receiving symbols are used in STBC decoding. Thus, among the signals previously received through the four antennas, the receiving end first buffers signals for two antennas and thereafter performs STBC decoding by using a total of four signals.

In step 413, symbols for the rest of antennas are detected using a SIC scheme.

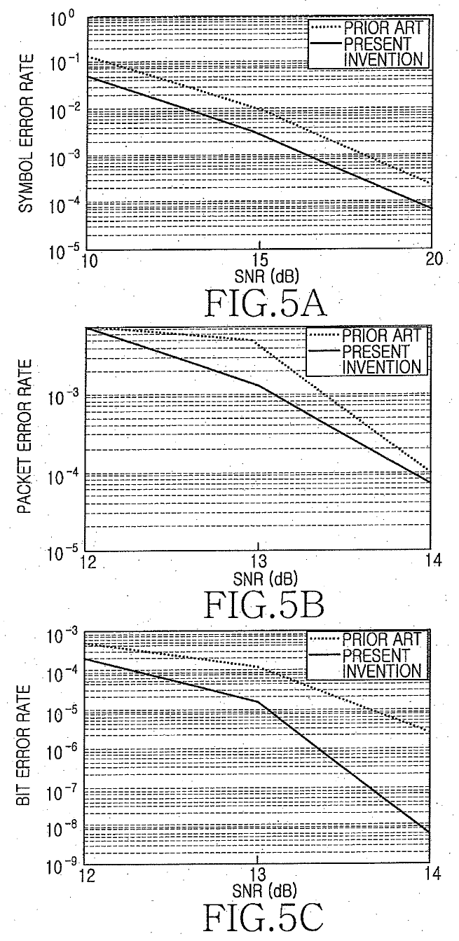

FIGS. 5A to 5C are graphs illustrating performance when data is encoded and decoded according to an exemplary embodiment of the present invention. It will be assumed hereinafter that a 4×4 MIMO system is used, and a Low Density Parity Check (LDPC) method is used for channel coding.

FIG. 5A illustrates a symbol error rate with respect to a Signal to Noise Ratio (SNR). FIG. 5B illustrates a packet error rate with respect to an SNR. FIG. 5C illustrates a bit error rate with respect to an SNR. The horizontal axes of FIGS. 5A, 5B and 5C represent SNR, and the vertical axes of FIGS. 5A, 5B and 5C respectively represent a symbol error rate, a packet error rate and a bit error rate.

As illustrated in FIGS. 5A to 5C, when using a data encoding/decoding method of an exemplary embodiment of the present invention, the symbol error rate, the packet error rate, and the bit error rate decrease.

According to an exemplary embodiment of the present invention, Space-Time Block Code (STBC) encoding is performed in a transmitting end by selecting two antennas, and thus computational complexity is reduced when symbols are detected in a receiving end. Further, an error rate decreases due to an STBC gain.

While the invention has been illustrated and described with reference to certain exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention as defined by the appended claims and their equivalents.

What is claimed is:

1. A transmitting apparatus in a multiple antenna communication system, the transmitting apparatus comprising:
an encoder for performing Space Time Block Code (STBC) encoding on certain symbols to be transmitted via Transmit(Tx) antennas which correspond to the smallest values among the maximum singular values of channel matrix, among Tx symbols;
a multiplexer for performing spatial multiplexing on the rest of symbols among the Tx symbols; and
a transmitter for transmitting the STBC encoded symbols and the spatial-multiplexed symbols through a plurality of antennas.

2. The transmitting apparatus of claim 1, wherein the transmitter transmits a control message containing information on the Tx antennas which correspond to the smallest values among the maximum singular values of channel matrix.

3. The transmitting apparatus of claim 1, further comprising a checker for evaluating a control message containing information on the Tx antennas which correspond to the smallest values among the maximum singular values of channel matrix.

4. The transmitting apparatus of claim 1, wherein the encoder performs STBC encoding by using an Alamouti scheme.

5. A transmitting apparatus in a multiple antenna communication system, the transmitting apparatus comprising:
an encoder for performing Space Time Block Code (STBC) encoding on certain symbols to be transmitted via Transmit(Tx) antennas which correspond to the smallest values among the maximum singular values of channel matrix among Tx symbols and for performing spatial multiplexing on the rest of symbols among the Tx symbols; and
a transmitter for transmitting symbols received from the encoder through a plurality of antennas.

6. The transmitting antennas of claim 5, wherein the transmitter transmits a control message containing information on the Tx antennas which correspond to the smallest values among the maximum singular values of channel matrix.

7. The transmitting apparatus of claim 5, further comprising a checker for evaluating a control message containing information on the Tx antennas which correspond to the smallest values among the maximum singular values of channel matrix.

8. The transmitting apparatus of claim 5, wherein the encoder performs STBC encoding by using an Alamouti scheme.

9. A receiving apparatus in a multiple antenna communication system, the receiving apparatus comprising:
a generator for sorting estimated channels so that channels for antennas which correspond to the smallest values among the maximum singular values of channel matrix are not nulled and for generating a subsystem by nulling certain channels among the sorted channels;
a decoder for performing Space Time Block Code (STBC) decoding on signals received through certain antennas in association with the subsystem among a plurality of antennas, so as to estimate Transmit (Tx) symbols; and
a detector for estimating symbols received through the rest of antennas by using the estimated Tx symbols.

10. The receiving apparatus of claim 9, further comprising a receiver for receiving, from a transmitting end, information on the antennas which correspond to the smallest values among the maximum singular values of channel matrix.

11. The receiving apparatus of claim 9, further comprising a transmitter for transmitting, to a transmitting end, information on the antennas which correspond to the smallest values among the maximum singular values of channel matrix.

12. The receiving apparatus of claim 9, wherein the generator sequentially nulls channels by using a Givens rotation matrix so as to generate a subsystem.

13. The receiving apparatus of claim 9, wherein the detector estimates a Tx symbol by using a Successive Interference Cancellation (SIC) scheme.

14. The receiving apparatus of claim 9, wherein the subsystem comprises a 2×2 subsystem.

15. A signal transmission method in a multiple antenna communication system, the signal transmission method comprising:
performing Space Time Block Code (STBC) encoding on certain symbols to be transmitted via Transmit(Tx) antennas which correspond to the smallest values among the maximum singular values of channel matrix among Tx symbols;
performing spatial multiplexing on the rest of symbols among the Tx symbols; and
transmitting the STBC encoded symbols and the spatial-multiplexed symbols through a plurality of antennas.

16. The signal transmission method of claim 15, further comprising transmitting, to a receiving end, a control message containing information on the Tx antennas which correspond to the smallest values among the maximum singular values of channel matrix.

17. The signal transmission method of claim 15, further comprising evaluating, from a receiving end, a control message containing information on the Tx antennas which correspond to the smallest values among the maximum singular values of channel matrix.

18. The signal transmission method of claim 15, wherein the performing of the STBC encoding is performed using an Alamouti scheme.

19. A signal detection method in a multiple antenna communication system, the signal detection method comprising:
sorting estimated channels so that channels for antennas which correspond to the smallest values among the maximum singular values of channel matrix are not nulled;
generating a subsystem by nulling certain channels among the sorted channels;
performing Space Time Block Code (STBC) decoding on signals received through certain antennas in association with the subsystem among a plurality of antennas, so as to estimate Transmit (Tx) symbols; and
estimating symbols received through the rest of antennas by using the estimated Tx symbols.

20. The signal detection method of claim 19, further comprising:
receiving, from a transmitting end, information on the antennas which correspond to the smallest values among the maximum singular values of channel matrix.

21. The signal detection method of claim 19, further comprising:
transmitting, to a transmitting end, information on the antennas which correspond to the smallest values among the maximum singular values of channel matrix.

22. The signal detection method of claim 19, wherein the generating of the subsystem is performed so that channels are sequentially nulled by using a Givens rotation matrix.

23. The signal detection method of claim 19, wherein the estimating of the symbols is performed using a Successive Interference Cancellation (SIC) scheme.

24. The signal detection method of claim 19, wherein the subsystem comprises a 2×2 subsystem.
